(19) United States
(12) Patent Application Publication
(10) Pub. No.: US 2010/0326809 A1
(43) Pub. Date: Dec. 30, 2010

(54) Safety switchgear for solar plants

(75) Inventors: Volker Lang, Bonn (DE); Ralph Linden, Cologne (DE); Gottfried Tharang, Wesseling (DE)

Correspondence Address: Leydig, Voit & Mayer, Ltd. (Frankfurt office), Two Prudential Plaza, Suite 4900, 180 North Stetson Avenue, Chicago, IL, 60601-6731, US

(73) Assignee: EATON INDUSTRIES GMBH, Bonn (DE)

(21) Appl. No.: 12/785,157

(22) Filed: May 21, 2010

(30) Foreign Application Priority Data
May 25, 2009 (DE) 10 2009 022 508.0

(51) Int. Cl. H01H 9/54; H02H 3/24; H02H 3/08; H01H 9/28

(52) U.S. Cl. 200/5 B; 361/92; 361/94; 200/43.11; 307/113

(57) ABSTRACT

The invention achieves the objective of ensuring that a solar installation mounted on a unit such as, for example, a residential house, can be safely switched off cost-effectively, whereby the consumers are to be galvanically disconnected from the solar installation, and the feed lines leading to the consumers are to be de-energized in case the safety switchgear has triggered a switch-off. A safety switchgear for a solar installation is proposed, whereby the solar installation consists of at least one photovoltaic element, of two connections, each to a feed line leading to a consumer, and said safety switchgear has a bypass that is situated between the two connections and upstream from the feed lines and that has at least one switching mechanism to close the contact points, whereby at least one additional switching mechanism for purposes of opening the contact points is arranged in each of the two feed lines. The invention is characterized in that the at least one switching mechanism in the bypass and the additional switching mechanisms present in each feed line of the photovoltaic installation are arranged, and can be jointly actuated by means of a coupler, in such a way that, when the safety switchgear is actuated, first the contact points of the at least one switching mechanism in each one of the two feed lines is opened and subsequently, with a time delay, the contact points of the at least one switching mechanism, which is situated in the bypass, are closed.

The invention relates to a safety switchgear for a solar installation. The solar panel has two connections, each to a feed line leading to a consumer. A bypass that is situated between the two connections and upstream from the feed lines has at least one switching mechanism to short-circuit the bypass. A switching mechanism here consists of a contact point made up of at least two contacts that can be opened and closed by means of the mechanism.

Solar panels are employed as a source of energy and, in the presence of solar radiation, they supply a useful current to consumers that are connected to them. It is frequently the case that several solar modules are combined to form a solar panel, thus increasing the generated power. Nowadays, solar panels are being mounted more and more often on the roofs of private homes and public buildings where they then serve as additional sources of energy for private households and public facilities.

In case of fire in the house or building, the fire department has to ensure that the entire site had been de-energized so as to prevent injuries due to electric shock or arcs when extinguishing agents are deployed.

German patent application DE 10 2005 018 173 A1 discloses a method for safely interrupting the operation of a photovoltaic installation by means of a safety device that is connected to the connections of the solar installation and that has a bypass to short-circuit the photovoltaic installation. This bypass can be actuated manually or automatically. Depending on the dimensions of the photovoltaic installation, high currents can flow to the consumers or through the bypass, and these currents have to be controlled if the safety device is actuated. For this reason, the safety device has to be dimensioned to be sufficiently large. The circuitry is completely made up of electronic semiconductor elements. Therefore, the installation is not galvanically disconnected from the consumers. Should one of the feed lines be defective, the installation is not disconnected.

German utility model DE 20 2006 007 613 U1 discloses a fire-protection device for a photovoltaic installation, whereby each feed line has a point of supply that can be interrupted. Even though the consumers are disconnected from the photovoltaic installation after the interruption, high and thus hazardous voltages can continue to exist between the feed lines all the way to the point of supply.

Before this backdrop, it is the objective of the invention to ensure that a solar installation mounted on a unit such as, for example, a residential house, can be reliably switched off cost-effectively and with a galvanic disconnection.

According to the invention, this objective is achieved by means of a device according to Claim 1. Advantageous embodiments of the device ensue from the subordinate claims.

The invention relates to a safety switchgear for a solar installation, whereby the solar panel has two connections, each to a feed line leading to a consumer, and said safety switchgear has a bypass that is situated between the two connections and upstream from the feed lines and that has at least one switching mechanism to short-circuit the bypass, whereby at least one additional switching mechanism is arranged in each of the two feed lines. Such a switching mechanism has at least one contact point made up of at least two contacts that can be opened and closed. Several such switching mechanisms can be arranged in a switching device. The safety switchgear has a “power” switching position in which the consumers connected to the solar panel are supplied with voltage, and a “safety” switching position in which the consumers are disconnected from the solar panel and the solar panel is short-circuited. Here, the term “consumer” also refers to a power inverter, which is usually necessary.

It has proven to be particularly advantageous for the switching mechanisms that are located in each feed line of the solar panel and that serve to disconnect connected consumers, and for the at least one mechanism that serves to close the contact points in the bypass of the solar panel to be coupled to each other in such a way that they can be actuated jointly but so that, after the actuation, first the at least one contact point of the at least one switching mechanism in each one of the two feed lines is opened and subsequently, with a time delay, the contact points of the at least one switching mechanism, which is situated in the bypass, are closed, in other words, in any case, they are switched in opposite directions.

Advantageously, the switching mechanisms for disconnecting connected consumers in each feed line of the solar panel and the at least one switching mechanism for closing the contact points in the bypass of the solar panel are located in two switching devices that are separate from each other such as, for example, in two load-break switches. Such load-break switches normally have several current paths that are separate from each other, each having at least one switching mechanism with at least one contact point in each case, so that the switching mechanisms that are present in each feed line of the solar panel for disconnecting connected consumers can be implemented in a single device.

The coupling of the two switching devices can be in the form of a suitable mechanical coupler.

The at least one switching mechanism in each one of the two feed lines can be actuated mechanically by means of a handle. It has been found to be especially advantageous to switch the at least one switching mechanism in each one of the two feed lines by means of an actuator. Such actuators can be working-current actuators or undervoltage actuators. These actuators can be controlled manually, for instance, by means of another switch, from a remote location. Advantageously, this switch is in the vicinity of the central power supply, for example, of a house, where the power distributor of the house is safeguarded by fuses and switching devices. This is often located in the basement or in a separate switch room. If the actuator employed is an undervoltage actuator, it can be coupled to the home network in such a manner that it is tripped when the voltage downstream from the house distributor drops. The special advantage of such an arrangement is that the solar panel is automatically disconnected from the network as soon as the house is de-energized, for instance, because the main switch has been switched off, without the need for auxiliary power. Such undervoltage actuators as well as the above-mentioned operating current actuators are standard devices that are widely available on the market. If the switching device is employed to disconnect the consumer, then there is no longer any voltage downstream from the disconnecting point.

A particularly preferred embodiment is characterized in that at least two closeable contact points are connected in series in the bypass. This can be carried out by using an appropriately connected, conventional switching device such as, for instance, a load-break switch.

The essential advantage of the invention lies in the coupling of the two switching devices of the safety switchgear for the solar installation and in the actuation of the disconnection of the solar panel by undervoltage actuators connected to the home network. For example, in case of fire, this causes the solar installation to be quickly switched off from the home network and from the consumers as soon as the home network itself is de-energized. The bypass can be subsequently short-circuited automatically by coupling the two switching devices, with a slight time delay, or else by means of a separate, for instance, manual actuation. As result of the time delay of the short-circuiting, the consumers are already disconnected from the solar panel and thus the flowing current has dropped down to zero. Consequently, the switching devices employed can be dimensioned smaller than they would have to be if the switch-off and short-circuiting were simultaneous.

Therefore, in an advantageous manner, the switch for actuating the at least one switching mechanism can be arranged in each feed line leading to the consumers in physical proximity to the main current distributor of the building, in other words, where, in case of fire, the fire department will disconnect the power supply to the burning building. The at least one switching mechanism itself, which is located in each feed line leading to the consumers, and the at least one switching mechanism for closing the contact points in the bypass of the solar panel can be arranged in the immediate vicinity of the solar panel, as a result of which it is possible to shorten the length of the lines that are still energized even after the consumers have been disconnected from the solar panel.

In such an arrangement of the circuitry, it is particularly advantageous that standard switching devices can be used such as, for example, load-break switches, which, as a mass-produced devices, are commercially available at inexpensive prices.

It has proven advantageous if the at least one switching mechanism present in each one of the two feed lines and the at least one switching mechanism for closing the contact points in the bypass of the solar panel are arranged in a shared, for example, weather-proof, housing. By the same token, it has proven to be advantageous to provide a lock-out element that prevents the safety switchgear from being easily switched from the safety position over to the power position. In particular, such a lock-out element can be secured in the safety position by means of a padlock. Conversely, it is likewise possible to provide a sealable lock-out element that prevents the at least one switching mechanism in each feed line from being moved from the power position to the safety position. This prevents unauthorized use of the safety switchgear.

As another advantage, the at least one switching mechanism in each feed line and the at least one switching mechanism in the bypass can have auxiliary contacts that allow the current switching state to be queried remotely. Such auxiliary contacts are widely available on the market as standard devices.

Coupling with one more switching mechanism can additionally ground the solar panel after the short-circuiting, thus achieving an extra level of safety against electric shocks.

Additional advantages, special features and practical refinements of the invention ensue from the embodiment examples below explained on the basis of figures.

The figures show the following:

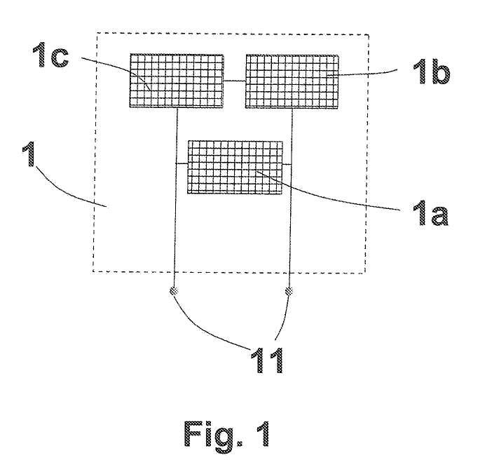

FIG. 1 a schematic depiction of a solar panel;

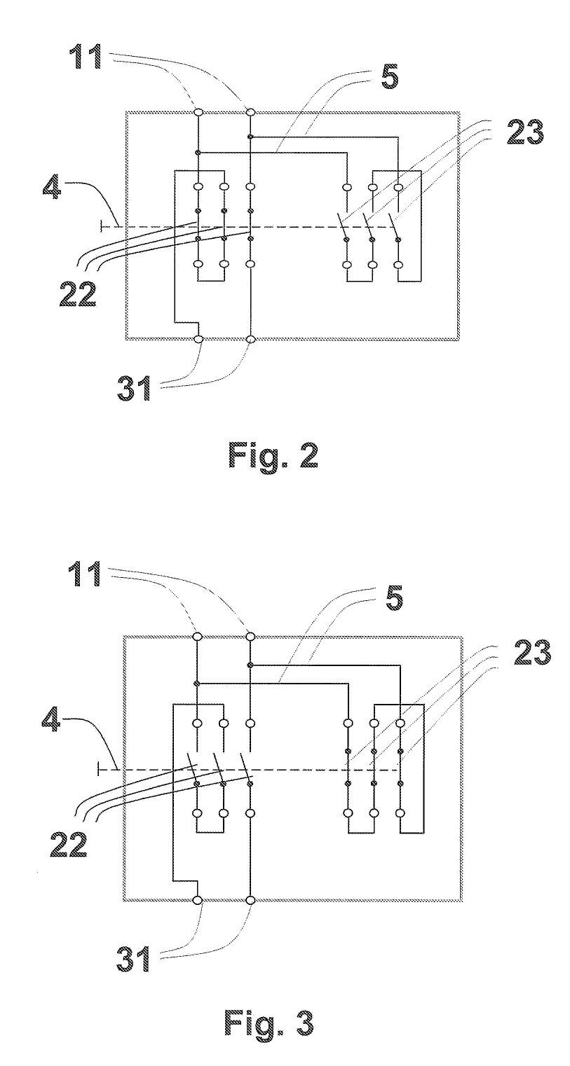

FIG. 2 a schematic depiction of the safety switchgear according to the invention, in the “power” switching position;

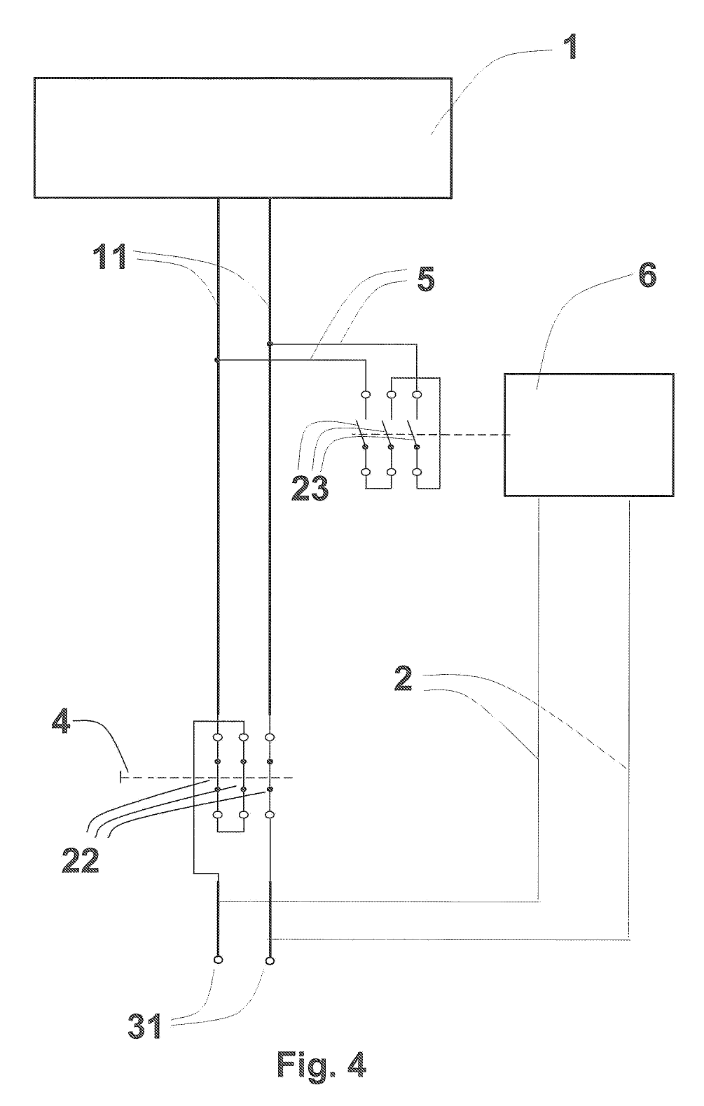

FIG. 3 a schematic depiction of the safety switchgear according to the invention, in the “safety” switching position.

A solar panel 1 normally consists of several solar modules 1a, 1b. FIG. 1 shows a solar panel 1 having, in each case, three serially connected solar modules 1a, 1b which are themselves connected in parallel. All of the solar modules 1a, 1b present in the solar panel can be contacted via two outputs 11 and provide electric energy in the presence of solar radiation.

FIG. 2 shows an inventive safety switchgear for safely switching off the solar installation 1 in the “power” switching position. A switching mechanism 22 for opening the contact points is arranged on the connections 11 of the solar installation 1. A current path of this switching mechanism 22 has a switching mechanism having a contact point, while the other current path of this switching mechanism 22 has two serially connected contact points. All of the contact points of this switching mechanism 22 are closed, as a result of which a voltage is present on the feed lines leading to the consumer 31. Moreover, the safety switchgear according to the invention has a bypass 5 that is located between the two connections 11 and upstream from the at least one switching mechanism 22 and a switching mechanism 23 having three serially connected contact points for closing purposes. The contact points of this switching mechanism 23 are open. As an alternative, there can be more or fewer contact points in the feed lines between the connections 11 and the feed lines leading to the consumer 31 as well as in the bypass 5. Moreover, an actuator 6 is shown which acts upon the at least one switching mechanism 22 for opening the contact points and which is connected to the power network of the house via the connections 7. In this context, the switching mechanisms 22 and 23 are in a housing 8 in the immediate vicinity of the solar panel 1. An optional switch for activating the actuator 6, in contrast, can be connected to the connections 7 and advantageously installed where the entire power supply, for instance, of a house, is located and safeguarded by means of fuses and switching devices. This is often located in the basement or in a separate switch room.

FIG. 3 shows a safety switchgear according to the invention for safely switching off the solar installation 1 in the “safety” switching position. In this position, all of the contact points of the switching mechanism 22 are open, as a result of which the current flow to the consumer is disconnected and there is no voltage in the feed lines leading to the consumer 31. The contact points of the switching 23 are closed, as a result of which the solar panel is short-circuited. Consequently, there is no longer any voltage downstream from the bypass in the direction of flow of the current.

### LIST OF REFERENCE NUMERALS

1 solar panel
1a, 1b solar module
11 connection for solar panel
2 coupling
22 switching mechanism with contact points that can be opened
23 switching mechanism with contact points that can be closed
3 consumer
31 feed lines leading to the consumer
4 handle
5 bypass
6 actuator
7 connection to the house network
8 housing

1. A safety switchgear for a photovoltaic installation (1), whereby the photovoltaic installation (1) consists of at least one photovoltaic element (1a), of two connections (11), each to a feed line (31) leading to a consumer (3), and said safety switchgear has a bypass (5) that is situated between the two connections (11) and upstream from the at least one switching mechanism (22) and that has at least one switching mechanism (23) to close contact points, whereby at least one additional switching mechanism (22) for purposes of opening the contact points is arranged in each of the two feed lines (31), characterized in that the at least one switching mechanism (23) in the bypass (5) and the additional switching mechanisms (22) present in each feed line (31) of the photovoltaic installation (1) are arranged, and can be jointly actuated by means of a coupler (2), in such a way that, when the safety switchgear is actuated, first the contact points of the at least one switching mechanism (22) in each one of the two feed lines (31) is opened and subsequently, with a time delay, the contact points of the at least one switching mechanism (23), which is situated in the bypass, are closed.

2. The safety switchgear according to claim 1, characterized in that the switching mechanism (23) in the bypass (5) and the additional switch mechanisms present in each feed line (31) of the photovoltaic installation (1) are arranged in switching devices that are separate from each other.

3. The safety switchgear according to one of the preceding claims, characterized in that the coupler of the two switching mechanisms (22), (23) is structured in such a way that the two switching mechanisms (22) and (23) are switched in opposite directions.

4. The safety switchgear according to one of the preceding claims, characterized in that the coupling of the two switching mechanisms (22), (23) is done by mechanical means.

5. The safety switchgear according to one of the preceding claims, characterized in that the switching mechanism (22) is mechanically actuated by means of a handle (4).

6. The safety switchgear according to one of claims 1 to 4, characterized in that the switching mechanism (22) is remotely controlled by means of an actuator (6).

7. The safety switchgear according to claim 6, characterized in that the switching mechanism (22) is remotely controlled by means of an undervoltage actuator (6) that is electrically connected to the home network.

8. The safety switchgear according to one of the preceding claims, characterized in that, after the at least one switching mechanism (23) has been closed, the generated short circuit is grounded.

9. The safety switchgear according to one of the preceding claims, characterized in that at least two switching mechanisms (23) are serially connected in the bypass (5).

10. The safety switchgear according to one of the preceding claims, characterized in that the bypass (5) is arranged in the vicinity of the solar installation (1).

11. The safety switchgear according to one of the preceding claims, characterized in that the at least one switching mechanism (23) and the bypass (5) having the at least one switching mechanism (23) for closing the contact points are arranged in the vicinity of the solar installation (1).

12. The safety switchgear according to one of the preceding claims, characterized in that the switching mechanisms (22) and (23) are arranged in a shared housing.

13. The safety switchgear according to one of the preceding claims, characterized in that a lock-out element that can be locked in the “safety” position of the switchgear prevents easy switching from the “safety” position into the “power” position.

14. The safety switchgear according to one of the preceding claims, characterized in that a lock-out element that can be sealed in the “power” position prevents the switching mechanism (22) from being mechanically moved out of the “power” position and into the “safety” position.

15. The safety switchgear according to one of the preceding claims, characterized in that the switching state of at least one of the switching mechanisms (22) and (23) can be queried by means of auxiliary contacts.
